(19) United States
(12) Patent Application Publication
(10) Pub. No.: US 2007/0000928 A1
(43) Pub. Date: Jan. 4, 2007

(54) WELDING JOINT FOR FUEL TANK

(75) Inventors: Takahiro Nishiyama, Kasugai-shi (JP); Kazutaka Katayama, Kasugai-shi (JP); Nobuaki Niki, Inuyama-shi (JP)

Correspondence Address: DARBY & DARBY P.C., P. O. BOX 5257, NEW YORK, NY, 10150-5257, US

(73) Assignee: TOKAI RUBBER INDUSTRIES, LTD., Komaki-shi (JP)

(21) Appl. No.: 11/427,159

(22) Filed: Jun. 28, 2006

(30) Foreign Application Priority Data
Jun. 30, 2005 (JP) 2005-192913

(51) Int. Cl. B62D 33/00

(52) U.S. Cl. 220/562

(57) ABSTRACT

A welding joint for a fuel tank includes a cylindrical portion and an annular weld portion. The weld portion has a multi-layer structure formed by layering an inner layer member made of a resin alloy material obtained by alloying a modified HDPE, to which a functional group having a high affinity to a hydroxyl group of EVOH is introduced, and EVOH, or by alloying the modified HDPE, normal HDPE and EVOH, and an outer layer member which uses the HDPE resin and/or modified HDPE resin and has high weldability to the fuel tank. Each of the inner and outer layer members is heat-welded to the fuel tank at a corresponding welding end surface. In a vicinity of at least one of the welding end surfaces of the inner outer layer members, a flow preventing portion that prevent a molten part of the inner layer member from flowing the outer layer member is provided.

### INCORPORATION BY REFERENCE

The present application claims priority under 35 U.S.C. §119 to Japanese Patent Application No. 2005-192913 filed on Jun. 30, 2005. The content of the application is incorporated herein by reference in its entirety.

### BACKGROUND OF THE INVENTION

1. Field of the Invention

This invention relates to a resin joint for connecting a piping tube or a connector to a resin fuel tank and, more particularly, to a resin welding joint that is welded to a fuel tank and that constitutes a connecting portion.

2. Description of the Related Art

A fuel tank mounted in an automobile is provided integrally with a joint adapted to connect the fuel tank to a tube or a connector for leading fuel, which is injected from an oil filler port, to the fuel tank.

Hitherto, for example, a rubber tube (or a rubber hose) has been used as the tube adapted to lead the fuel, which is injected from the oil filler port, to the fuel tank. However, in recent years, from the viewpoint of environmental protection, regulations against the permeation of fuel through a hose to the outside have become strict. Thus, a rubber-resin composite material tube constituted by a rubber hose having resin barrier layer, a rubber tube made of a fluoro-rubber having fuel impermeability, or a resin tube made only of a resin has been employed as the piping tube.

Hitherto, for example, a connecting structure shown in FIGS. 11A and 11B has been employed as a structure for connecting such a tube to a fuel tank.

As shown in FIGS. 11A and 11B, reference numeral 200 designates a fuel tank. Reference numeral 202 denotes a welding joint which is also made of resin. The welding joint 202 is provided integrally with the fuel tank 200 by heat-welding.

The welding joint 202 has a cylindrical portion serving as a tube insertion portion. An annular flange-like portion 206 is provided to project from an outer circumferential surface of the cylindrical portion 204.

Reference numeral 208 designates a resin tube used to lead fuel, which is injected from the oil filler port, to the fuel tank. As shown in FIG. 11B, a bellow portion 210 is provided in the resin tube 208 to provide flexibility thereto.

In FIGS. 11B and 12, reference numeral 212 denotes a connector (a quick connector). The resin tube 208 is connected to the welding joint 202 through this connector.

The connector 212 includes a resin connector body 214 and a retainer 216 that is also made of resin.

The connector body 214 has a nipple portion 218 at one of the axial sides thereof. Also, the connector body 214 has at the other of the axial sides thereof a socket-like retainer holding portion 230 which holds the retainer 216 that is elastically inserted into the holding portion 230.

The nipple portion 218 fixes the resin tube 208 by press-fitting the resin tube 208 onto the nipple portion 218. A cross-sectionally sawtooth-shaped slip-off-preventing portion having a plurality of annular projections 232 axially separated at uniform intervals is formed on the outer circumference surface of the nipple portion 218. Also, a plurality of O-rings (sealing rings) 234 are held on the inner circumferential surface thereof.

On the other hand, circular-arc-like concave portion 236 is provided in the socket-like retainer holding portion 230. Also, a partially-ring-like portion 238 that is shaped correspondingly to the concave portion 236 is provided in the retainer holding portion 230.

The retainer 216 is adapted to be entirely elastically deformable in a radial direction. The retainer 216 has a circular-arc-like groove 240 elastically fitted onto the partially-ring-like portion 238, a tapered guide surface 242 used to axially insert and guide the flange-like portion 206 at the side of the welding joint 202 and to elastically enlarge the entire retainer 216, and a circular-arc-like engaging concave portion 244 in which the flange-like portion 206 is engaged.

This connecting structure is such that an end portion of the resin tube 208 is forcibly press-fitted onto the nipple portion 218 of the connector body 214 and is fixed thereto.

At that time, as shown in FIG. 11B, the end portion of the resin tube 208 is enlarged and securely fastens the nipple portion 218 with strong fastening force.

The end portion of the resin tube 208 is thus fixed to the connector body 214 by the fastening force and the biting action of the annular projections 232 provided in the nipple portion 218.

In conjunction with this, the retainer 216 is attached to and is held by the connector body 214. In this state, the connector 212 is fitted onto the cylindrical portion 204 of the welding joint 202.

At that time, the retainer 216 held by the connector body 214 is elastically enlarged by the flange-like portion 206. Then, when the flange-like portion 206 reaches the engaging concave portion 244, the retainer 216 elastically shrinks, so that the flange-like portion 206 and the engaging concave portion 244 are engaged with each other.

Simultaneously with this, apart of the cylindrical portion 204, which is closer to the end thereof than the flange-like portion 206, is fitted into the O-ring 234 provided on the inner circumferential side of the connector body 214. This results in an airtight seal between the cylindrical portion 204 and the connector body 214.

Meanwhile, it has been conceived that differently from this technique, the resin tube 208 is connected to the fuel tank by inserting the resin tube 208 directly into the cylindrical portion 204 of the welding joint 202 without using the connector 212.

The welding joint for connecting such a connector (a quick connector) to or for connecting the fuel piping tube directly to the welding joint is integrally welded to the fuel tank by heat-welding, as described above. In the case of constituting the connecting portion of the tube by the welding joint, the following problems occur.

Hitherto, HDPE (high-density Polyethylene) has often been used as the material of an outer layer of a fuel tank. Therefore, it has been demanded that the welding joint to be provided integrally with the fuel tank can be welded to this fuel tank.

Thus, it has been considered that the entire welding joint including the cylindrical portion is made of the same HDPE resin material to realize such welding. Although the HDPE resin excels in weldability to the fuel tank, the HDPE resin is insufficient in fuel-impermeability. This causes a problem in that the permeation of fuel to the outside occurs.

JP-A-2002-254938 discloses a technique of constituting the welding joint by stacking in a radial direction an outer layer member, which has weldability to a fuel tank, and an inner layer member constituted by a resin material having fuel impermeability (barrier ability), aiming at solving the problem of the fuel impermeability.

FIG. 13 shows a specific example.

In FIG. 13, reference numeral 246 designate a resin fuel tank constituted by stacking an outer layer 246-1, an inner layer 246-3, which are made of HDPE resin, and a barrier layer 246-2, which is made of EVOH resin that excels in fuel impermeability.

Reference numeral 248 denotes a welding joint that is integrally welded to the fuel tank 246 and that is made of resin. This welding joint 248 has a cylindrical portion 252, which is a connecting portion (a plug portion) of a tube 258, and a weld portion 250 that is a base end portion thereof. The welding joint 248 is heat-welded to the fuel tank 246 at the weld portion 250.

The cylindrical portion 252 is configured so that the outer layer member 254 and the inner layer member 256 are made of different resin materials, respectively. Particularly, the outer layer member 254 is made of the same resin as the material of the weld portion 250. The inner layer material 256 is made of a barrier material, such as PA (polyamide) resin, which is superior in fuel impermeability to the above-mentioned resin material.

Incidentally, reference numeral 260 designates a hose band that clamps the tube 258 that is fitted thereinto.

In a case where the outer layer member 254 of the cylindrical portion 252 and the weld portion 250 are made of the same HDPE resin material, which has high weldability to the fuel tank 246, in the welding joint 248 having this structure, the HDPE resin is insufficient in fuel impermeability (thus, the inner layer member 256 of the cylindrical portion 252 is made of a barrier material in the welding joint 248 shown in FIG. 13). Therefore, even in a case where the cylindrical portion 252 assures sufficient fuel impermeability, the weld portion 250 made of HDPE resin is, so to speak, in an exposed state. Consequently, there is a problem inherent in this related welding joint 248 in that fuel contained in the fuel tank 246 permeates through the weld portion 250 to the outside.

Meanwhile, JP-A-2002-241546 discloses a technique of alloying EVOH copolymer and a polyolefin resin and constituting a fuel handling member, which has a resin phase separation structure including a sea-island structure employing EVOH as a continuous phase (a sea) and also employing polyolefin as a separated phase (an island), with such a resin alloy material.

It is conceivable that the weld portion 250 is constituted by using the resin alloy material disclosed in JP-A-2002-241546 in the welding joint 248.

It can be expected that this configuration imparts excellent weldability of HDPE and high fuel impermeability of EVOH to the weld portion 250.

However, EVOH is not always sufficient in water resistance. Thus, this configuration has a problem in that in a case where the weld portion is exposed to moisture for a longtime, the weld portion adsorbs moisture, with the result in deterioration of fuel impermeability and in lowering the degree of the welding strength thereof. Additionally, the weld portion 250 of the welding joint 248 is highly likely to be exposed to moisture. Therefore, in a case where the entire weld portion 250 is made of such a resin alloy material, the fuel impermeability and the welding strength may be deteriorated with time.

### SUMMARY OF THE INVENTION

Thus, the inventors of the present invention devised a technique of forming a structure by layering an inner layer made of a resin alloy material obtained by alloying a modified HDPE (high density polyethylene), to which a functional group having a high affinity to a hydroxyl group of EVOH (ethylene-vinyl alcohol) is introduced, and EVOH, or by alloying the modified HDPE, normal HDPE and EVOH, and an outer layer that uses the HDPE resin and/or modified HDPE resin.

FIGS. 14A and 14B show a specific example of this technique.

In these figures, reference numeral 262 denotes a welding joint, the entire cylindrical portion 264 of which is made of the resin alloy material.

Reference numeral 266 designates a weld portion that has a large-diameter flange portion 268 and a down portion 270 that projects from the outer circumferential part of the flange portion 268 toward the fuel tank 246 and that is annular-shaped around an opening of the fuel tank 246.

The weld portion 266 has a two-layer structure including an inner layer member 272 and an outer layer member 274.

The inner layer member 272 is made of the resin alloy material and is formed integrally with the cylindrical portion 264. The inner layer member 272 is integrally welded to the fuel tank 246 by employing an end surface of the down portion 270 as a welding end surface 272A.

The outer layer member 274 is provided mainly to reinforce the weldability to fuel tank 246, which is exhibited by the inner layer member 272, that is, is mainly intended to reinforce such weldability. The outer layer member 274 is made of a HDPE resin or a modified HDPE resin, which has high weldability to the fuel tank 246.

Also, the outer layer member 274 is integrally welded to the fuel tank 246 by employing an end surface of the down portion 270 as a welding end surface 274A.

As described above, hitherto, EVOH has been known as a material that excels in gas barrier property. The resin alloy material obtained by alloying the modified HDPE and such EVOH exhibits excellent weldability to the fuel tank 246 due to HDPE contained therein and also exhibits high fuel impermeability (barrier ability) due to EVOH. Thus, the welding joint 262 shown in FIGS. 14A and 14B is enabled to have high fuel impermeability while maintaining the excellent weldability of the weld portion 266. Consequently, the welding joint 262 can solve the problem that fuel permeates through the weld portion 266 to the outside.

Also, the inner layer member 272 made of the resin alloy material is externally covered with the outer layer member 274 made of the HDPE resin having high water resistance. Thus, the inner layer member 272 included in the weld portion 266 can be shut off and protected from moisture by the outer layer member 274 made of the HDPE resin. Consequently, the excellent fuel impermeability and the excellent welding strength can stably be maintained for a long time.

Meanwhile, when the welding joint 262 is heat-welded to the fuel tank 246 at the welding end surfaces 272A and 274A of the weld portion 266, the following problems may occur.

In a case where the welding joint 262, more specifically, the weld portion 266 is heat-welded to the fuel tank 246, usually, the welding end surfaces 272A and 274A of the inner layer member 272 and the outer layer member 274 are welded by being aligned with each other, as shown in FIG. 14B. In this case, the inner layer member 272 is high in weldability, as compared with a resin member made singly of EVOH. However, the weldability of the inner layer member 272 is lower than that of the HDPE resin. Therefore, when the welding end surfaces 272A and 274A are welded to the fuel tank 246, the welding between the welding surface 274A of the outer layer member 274 and the fuel tank 246 is disturbed by molten resin at the welding end surface 272A of the inner layer member 272 in a case where this molten resin flows to the welding end surface 274A of the outer layer member 274.

The present invention is made in view of the aforementioned circumstances. Accordingly, an object of the invention is to provide a welding joint for a fuel tank, which is adapted so that in a case where at least a weld portion is configured to have a structure formed by layering an inner layer made of a resin alloy material which is obtained by using singly a modified HDPE or which is obtained by alloying HDPE and EVOH, and an outer layer that uses a HDPE resin and/or modified HDPE resin, the welding between the outer layer member and the fuel tank is not disturbed by a molten part of the inner layer member when the weld portion is welded to the fuel tank, to thereby realize highly reliable and high strength welding.

According to an aspect of the invention, there is provided a welding joint (hereunder referred to as a first welding joint) for a fuel tank, including: a cylindrical portion serving as a connection portion of a piping tube or connector; and an annular weld portion provided at abase end part of the cylindrical portion, the weld portion being integrally heat-welded to a peripheral part of an opening portion of a resin fuel tank, wherein at least the weld portion is configured to have a multi-layer structure formed by layering an inner layer member made of a resin alloy material obtained by alloying a modified HDPE, to which a functional group having a high affinity to a hydroxyl group of EVOH is introduced, and EVOH, or by alloying the modified HDPE, normal HDPE and EVOH, and an outer layer member which uses the HDPE resin and/or modified HDPE resin and has high weldability to the fuel tank, each of the inner layer member and the outer layer member is heat-welded to the fuel tank at a corresponding welding end surface, the welding end surface of the outer layer member is projected toward the fuel tank from the welding end surface of the inner layer member, and a step-like portion is formed between the welding end surfaces, before heat-welded

According to another aspect of the invention, there is provided a welding joint (hereunder referred to as a second welding joint) for a fuel tank, including: a cylindrical portion serving as a connection portion of a piping tube or connector; and an annular weld portion provided at a base end part of the cylindrical portion, the weld portion being integrally heat-welded to a peripheral part of an opening portion of a resin fuel tank, wherein at least the weld portion is configured to have a multi-layer structure formed by layering an inner layer member made of a resin alloy material obtained by alloying a modified HDPE, to which a functional group having a high affinity to a hydroxyl group of EVOH is introduced, and EVOH, or by alloying the modified HDPE, normal HDPE and EVOH, and an outer layer member which uses the HDPE resin and/or modified HDPE resin and has high weldability to the fuel tank, each of the inner layer member and the outer layer member is heat-welded to the fuel tank at a corresponding welding end surface, and the welding end surfaces are formed to be a slope or a curved surface so that a distance between the weld portion and the fuel tank gradually increases toward an inner end of the welding end surface of the inner layer member from an outer end of the welding end surface of the outer layer member, before heat-welded.

According to another aspect of the invention, there is provided a welding joint (hereunder referred to as a third welding joint) for a fuel tank, including: a cylindrical portion serving as a connection portion of a piping tube or connector; and an annular weld portion provided at a base end part of the cylindrical portion, the weld portion being integrally heat-welded to a peripheral part of an opening portion of a resin fuel tank, wherein at least the weld portion is configured to have a multi-layer structure formed by layering an inner layer member made of a resin alloy material obtained by alloying a modified HDPE, to which a functional group having a high affinity to a hydroxyl group of EVOH is introduced, and EVOH, or by alloying the modified HDPE, normal HDPE and EVOH, and an outer layer member which uses the HDPE resin and/or modified HDPE resin and has high weldability to the fuel tank, each of the inner layer member and the outer layer member is heat-welded to the fuel tank at a corresponding welding end surface, and an annular concave groove portion extending around the opening portion is provided on least one of a part of the welding end surface of the outer layer member, which is located at the side of the inner layer member, and a part of the welding end surface of the inner layer member, which is located at the side of the outer layer member, before heat-welded.

According to another aspect of the invention, there is provided a welding joint (hereunder referred to as a fourth welding joint) for a fuel tank, including: a cylindrical portion serving as a connection portion of a piping tube or connector; and an annular weld portion provided at a base end part of the cylindrical portion, the weld portion being integrally heat-welded to a peripheral part of an opening portion of a resin fuel tank, wherein at least the weld portion is configured to have a multi-layer structure formed by layering an inner layer member made of a resin alloy material obtained by alloying a modified HDPE, to which a functional group having a high affinity to a hydroxyl group of EVOH is introduced, and EVOH, or by alloying the modified HDPE, normal HDPE and EVOH, and an outer layer member which uses the HDPE resin and/or modified HDPE resin and has high weldability to the fuel tank, each of the inner layer member and the outer layer member is heat-welded to the fuel tank at a corresponding welding end surface, and an annular projection extending around the opening portion and projecting toward the fuel tank is provided on a part of the welding end surface of the outer layer member, which is located at the side of the inner layer member, before heat-welded.

According to another aspect of the invention, there is provided a welding joint (here under referred to as a fifth welding joint) for a fuel tank, including: a cylindrical portion serving as a connection portion of a piping tube or connector; and an annular weld portion provided at a base end part of the cylindrical portion, the weld portion being integrally heat-welded to a peripheral part of an opening portion of a resin fuel tank, wherein at least the weld portion is configured to have a multi-layer structure formed by layering an inner layer member made of a resin alloy material obtained by alloying a modified HDPE, to which a functional group having a high affinity to a hydroxyl group of EVOH is introduced, and EVOH, or by alloying the modified HDPE, normal HDPE and EVOH, and an outer layer member which uses the HDPE resin and/or modified HDPE resin and has high weldability to the fuel tank, and an annular cutout portion extending around the opening portion and concaved from an inner surface of the inner layer member toward the outer layer member is provided in a part of the inner layer member, which is located higher than the welding end surface of the inner layer member, before heat-welded.

As described above, according to the first welding joint of the invention, the welding end surface of the outer layer member is projected toward the fuel tank from the welding end surface of the inner layer member. Also, the step-like portion is formed between the welding end surfaces. According to the first welding joint of the invention, when the weld portion of the first welding joint is welded to the fuel tank, first, the welding end surface of the outer layer member is welded to the fuel tank. Subsequently, the welding end surface of the inner layer member is welded to the fuel tank. Thus, there is no fear that a molten part of the inner layer member at the welding end surface may flow into a space between a part of the outer layer member, which is located at the side of the welding end surface, and the fuel tank and may disturb the welding therebetween. Consequently, according to the first welding joint of the invention, the weld portion can be welded to the fuel tank at high welding strength. Also, the reliability of calculation of the welding strength can be enhanced.

Also, the outer layer member made of HDPE resin excels in water resistance, as compared with the inner layer member including EVOH. Thus, even in a case where the weld portion is wetted down or where the weld down portion is immersed in water, the invention can obtain an advantage in that the welding strength can be maintained at a high level.

Next, according to the second welding joint of the invention, the welding end surface of the outer layer member and the welding end surface of the inner layer member are formed to be a slope or a curved surface so that the distance between the weld portion and the fuel tank gradually increases toward the inner end of the welding end surface of the inner layer member from the outer end of the welding end surface of the outer layer member. When the weld portion is welded, first, the welding end surface of the outer layer member is welded. Subsequently, the welding end surface of the inner layer member is welded. Also, a molten part of each of the outer layer member and the inner layer member flows from the outer end of the welding end surface to the inner end of the welding end surface. Thus, there is no fear that a part of the inner layer member, which is molten at the welding end surface, disturbs the welding between the outer layer member 38 and the fuel tank. Consequently, according to the second welding joint of the invention, the strength of the weld portion can be set at a high value. The reliability of the welding strength can be enhanced.

The third welding joint of the invention is configured so that an annular concave groove portion extending around the opening portion is provided at least one of a part of the welding end surface of the outer layer member, which is located at the side of the inner layer member, and a part of the welding end surface of the inner layer member, which is located at the side of the outer layer member. According to the third welding joint of the invention, even in a case where a part of the inner layer member is molten at the welding end surface when welded, the molten part of the inner layer member flows into the concave groove portion and is stopped therein. Thus, the molten part of the inner layer member is prevented from flowing into the welding end surface of the outer layer member. Consequently, according to the third welding joint of the invention, the strength of the weld portion can be set at a high value. Also, the reliability of the welding strength can be enhanced.

Meanwhile, the fourth welding joint of the invention is configured so that an annular projection extending around the opening portion and projecting toward the fuel tank is provided on a part of the welding end surface of the outer layer member, which is located at the side of the inner layer member. According to the fourth welding joint of the invention, when the weld portion is welded to the fuel tank, the partially projecting annular projection is first welded thereto. Thus, the molten part of the inner layer member is prevented from flowing into a part provided at the side of the outer layer member. Consequently, according to the fourth welding joint of the invention, the strength of the weld portion can be set at a high value. Also, the reliability of the welding strength can be enhanced.

Next, the fifth welding joint of the invention is configured so that an annular cutout portion extending around the opening portion and concaved from the inner surface of the inner layer member toward the outer layer member is provided in a part of the inner layer member, which is located higher than the welding end surface of the inner layer member. According to the fifth welding joint of the invention, the strength of the part of the inner layer member, which is located higher than the welding end surface, is reduced by the annular cutout portion. Thus, when the welding end surface of the inner layer member is pushed down toward the fuel tank after heat-molten, the inner layer member is deformed in a direction to fill in the cutout portion. Consequently, the molten part of the inner layer member can be prevented from flowing into a part provided at the side of the outer layer member. Thus, according to the fifth welding joint of the invention, the strength of the weld portion can be set at a high value. Also, the reliability of the welding strength can be enhanced.

### BRIEF DESCRIPTION OF THE DRAWINGS

FIG. 1 is a perspective view illustrating a welding joint that is an embodiment of the invention in a state in which the welding joint is welded to a fuel tank;

FIGS. 2A and 2B are perspective views illustrating the welding joint according to the embodiment in a state in which the welding joint is not welded to the fuel tank yet;

FIG. 3 is a cross-sectional view illustrating the welding joint according to the embodiment in the state in which the welding joint is not welded to the fuel tank yet;

FIG. 4 is an enlarged view of the welding joint shown in FIG. 3;

FIGS. 5A and 5B are schematic views illustrating an example of the existence form of EVOH of a resin alloy material used in the embodiment;

FIG. 6 is a view illustrating another embodiment of the invention;

FIG. 7 is a view illustrating still another embodiment of the invention;

FIG. 8 is a view illustrating yet another embodiment of the invention;

FIG. 9 is a view illustrating a further embodiment of the invention;

FIG. 10 is a view illustrating a further embodiment of the invention;

FIGS. 11A and 11B are explanatory views illustrating a related method of connecting a resin tube to a fuel tank;

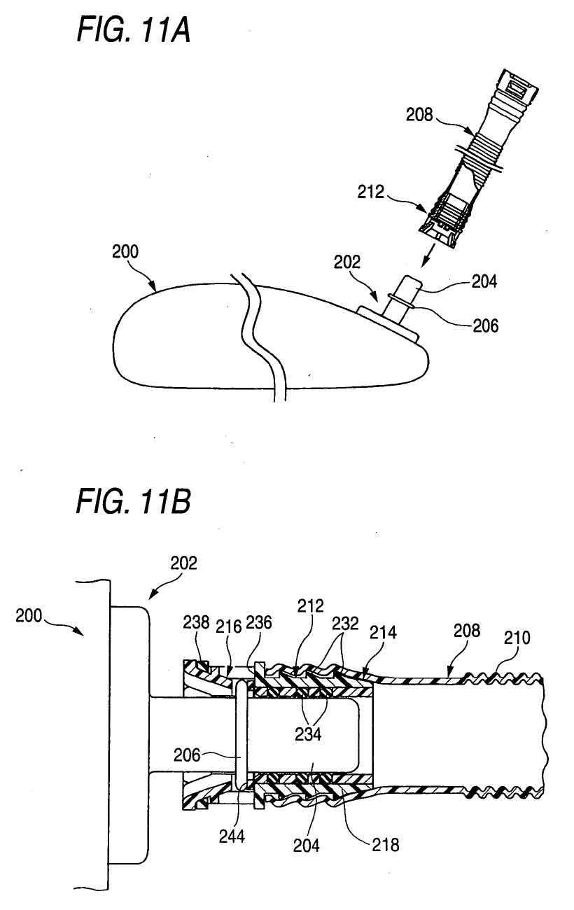

FIG. 12 is an exploded view illustrating a related connecting structure;

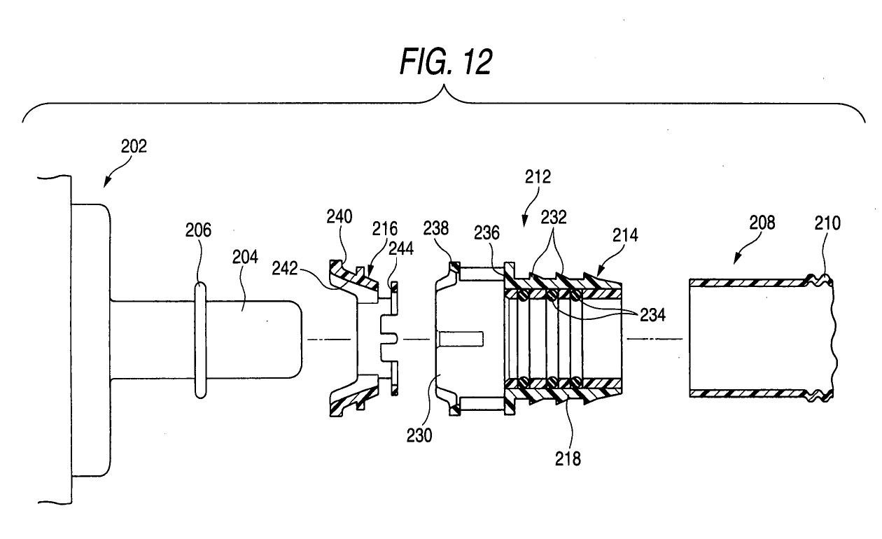

FIG. 13 is a view illustrating an example of the configuration of a related welding joint; and

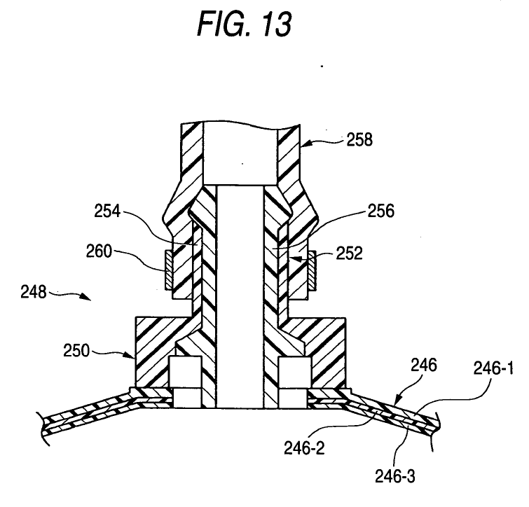

FIGS. 14A and 14B are views illustrating a related welding joint.

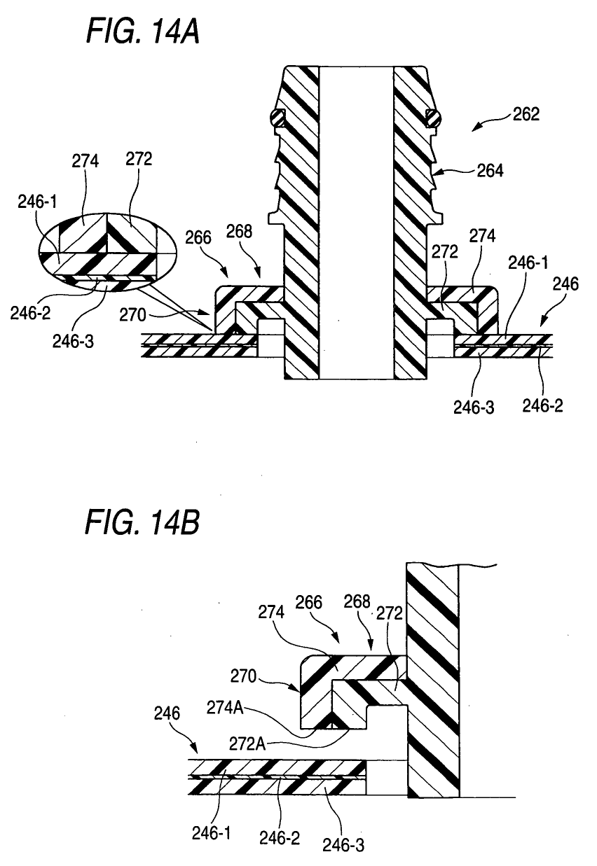

### DETAILED DESCRIPTION OF THE PREFERRED EMBODIMENT

Next, embodiments of the invention is described in detail below with reference to the accompanying drawings.

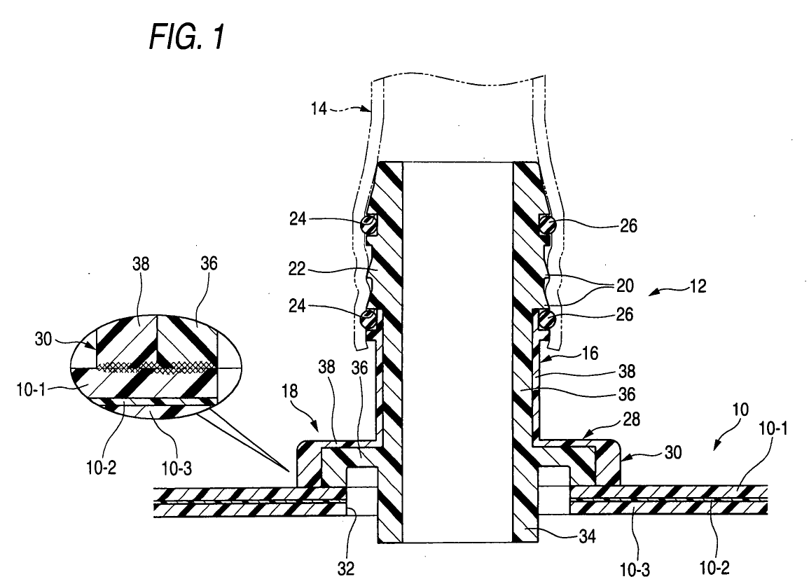

In FIG. 1, reference numeral 10 designates a resin fuel tank. In this embodiment, the resin fuel tank 10 has an outer layer member 10-1 and an inner layer member 10-3, which are made of HDEP resin. Also, the fuel tank 10 has a cross-sectional structure in which a thin barrier member 10-2 is sandwiched by the outer layer member 10-1 and the inner layer member 10-3.

Incidentally, the barrier member 10-2 also constitutes an inner layer opposed to the outer layer 10-1.

Reference numeral 12 denotes a resin welding joint that has a cylindrical portion 16, which serves as a connecting portion for a piping tube (hereunder referred to simply as a tube) 14, and a weld portion 18 that is a base end part thereof.

The tube 14 is press-fitted onto this cylindrical portion 16 and is connected to the fuel tank 10 through such a welding joint 12.

A cross-sectionally sawtooth-shaped slip-off-preventing portion 22 having a plurality of annular projections 20 axially separated at intervals is provided on the outer circumferential surface of the cylindrical portion 16.

Annular grooves 24 are formed at an end part and an middle part of the cylindrical portion 16. Elastic sealing O-rings 26 are mounted in the grooves 24, respectively.

Each of the O-rings 26 functions to air tightly seal between the outer circumferential surface of the cylindrical portion 16 and the inner circumferential surface of the tube 14.

The slip-off-preventing portion 22 is configured to make the annular projections 20 have a cross-sectionally acute-angled edge that bites into the inner surface of the tube 14, and to function to prevent the tube 14 from slipping off the welding joint.

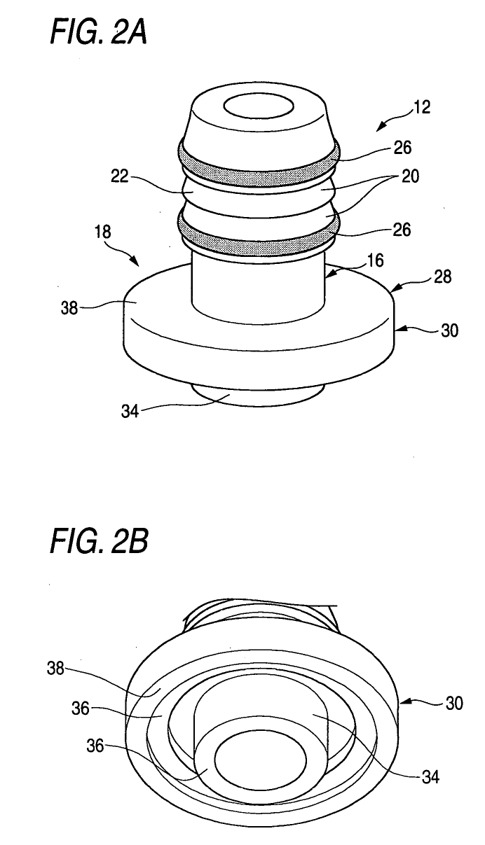

The weld portion 18 has a large-diameter disk-like flange portion 28, which is radially and outwardly extended from the cylindrical portion 16 as shown in FIG. 2, and a down portion 30 that extends downwardly from the outer circumferential end part of the flange portion 28 toward the fuel tank 10 and is annular-shape around an opening portion 32 of the fuel tank 10. The weld portion 18 is integrally heat-welded to the peripheral edge part of the opening portion 32 in the fuel tank 10, particularly, to the outer layer member 10-1, at the end surface of the down portion 30.

The welding joint 12 is also provided with an annular projection portion 34 projecting in a direction opposite to the cylindrical portion 16, that is, projecting toward the inside of the opening portion 32.

The projection portion 34 is used to connect a resin casing such as a valve disposed in the fuel tank 10.

In this embodiment, a lower half part of the cylindrical portion 16, as viewed in this figure, more specifically, a part of the cylindrical portion 16, which is lower than the slip-off-preventing portion 22 serving as a plug portion of the tube 14, has a two-layer structure including an outer layer member 38 and an inner layer member 36 that composes most of the part of the cylindrical portion 16.

Incidentally, a resin alloy material obtained by alloying a modified HDPE (high density polyethylene), to which a functional group having a high affinity to a hydroxyl group of EVOH (ethylene-vinyl alcohol) is introduced, and EVOH, or by alloying the modified HDPE, normal HDPE and EVOH is used as the material of the inner layer member 36.

Also, the entire upper half part of the cylindrical portion 16 and the entire projection portion 34 are made of the same resin alloy material as that of the inner layer member 36 of the lower half part of the cylindrical portion 16.

On the other hand, HDPE resin having a high weldability to the fuel tank 10 or particularly to the outer layer member 10-1 is used as the material of the outer layer member 38 of the lower half part of the cylindrical portion 16 (incidentally, the modified HDPE resin or a mixture material of the normal HDPE resin and the modified HDPE resin may be used as the material of the outer layer member 38).

The entire weld portion 18 including the entire flange portion 28 and the entire annular down portion 30 is configured to have a two-layer structure in which the inner layer member 36 and the outer layer member 38 are layered.

The material of the inner layer member 36 of the weld portion 18 is the same resin alloy material as that of the inner layer member 36 of the lower half part of the cylindrical portion 16. The inner layer member 36 of the weld portion 18 is formed integrally with the inner layer member of the lower half part of the cylindrical portion 16.

The material of the outer layer member 38 of the weld portion 18 is the same resin material as that of the outer layer member 38 of the cylindrical portion 16. The outer layer member 38 of the weld portion 18 is formed integrally with the outer layer member 38 of the lower half of the cylindrical portion 16.

Incidentally, the inner layer member 36 and the outer layer member 38 are integrally formed by two-color molding.

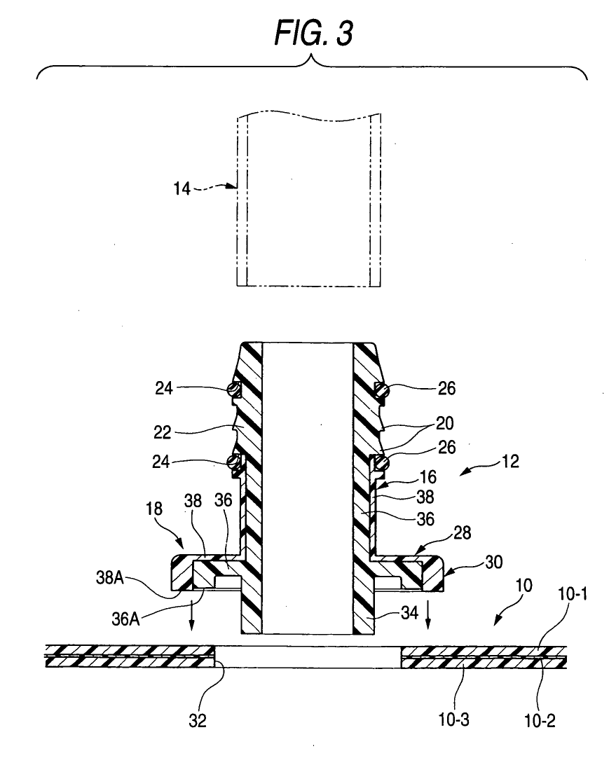

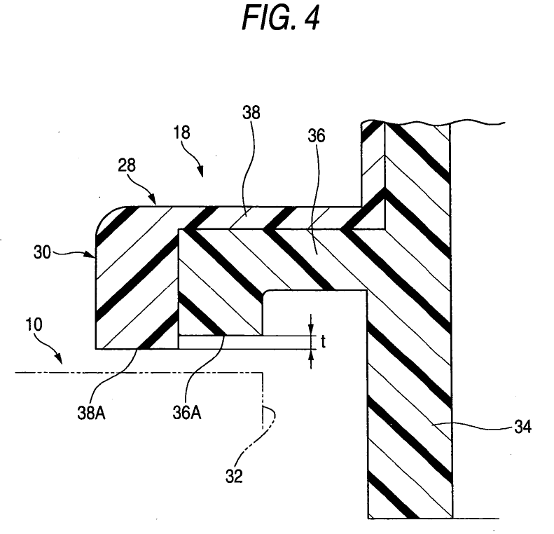

FIGS. 3 and 4 show the welding joint 12 in a state before welded to the fuel tank 10.

In these figures, reference numerals 36A and 36B designate the welding end surface of the inner layer member 36 and the welding end surface of the outer layer member 38, respectively.

As shown in these figures, the welding end surface 38A of the outer layer member 38 is protruded by t from the welding end surface 36A of the inner layer member 36 toward the fuel tank 10. Also, a step-like portion is formed between the welding end surfaces 38A and 36A.

In this embodiment, the welding joint 12 is configured so that each of the outer layer member 38 and the inner layer member 36 is welded to the fuel tank 10 at a corresponding one of the welding end surfaces 38A and 36A. Thus, the dimension t is set to be smaller than a welding margin.

When the welding joint 12 is heat-welded to the fuel tank 10 in this embodiment, first, the welding end surface 38A of the outer layer member 38 is welded to the fuel tank 10 due to the step-like portion between the welding end surface 38A of the outer layer member 38 and the welding end surface 36A of the inner layer member 36. Subsequently, the welding end surface 36A of the inner layer material 36 is welded to the fuel tank 10.

In this embodiment, the entire weld portion 18 is configured to have the multi-layer structure formed by layering the inner layer member 36, which is made of the resin alloy material obtained by alloying the modified HDPE and EVOH, and the outer layer member 38 made of the HDPE resin. Also, each of the inner layer member 36 and the outer layer member 38 is welded to the fuel tank 10. Thus, the welding strength, at which the weld portion 18 is welded to the fuel tank 10, can be increased. Additionally, the problem of permeation of the fuel contained the fuel tank 10 to the outside through the weld portion 18 can be solved.

In this embodiment, when the weld portion 18 of the welding joint 12 is welded to the fuel tank 10, first the welding end surface 38A of the outer layer member 38 is welded to the fuel tank 10. Subsequently, the welding end surface 36A of the inner layer member 36 is welded to the fuel tank 10. Thus, there is no fear that a molten part of the inner layer member 36 at the welding end surface 36A may flow into a space between a part of the outer layer member 38, which is located at the side of the welding end surface 38A, and the fuel tank 10 and may disturb the welding therebetween. The weld portion 18 can be welded to the fuel tank 10 at high welding strength. Also, the reliability of calculation of the welding strength can be enhanced.

The outer layer member 38 made of HDPE resin excels in water resistance, as compared with the inner layer member including EVOH. Thus, even in a case where the weld portion 18 is wetted down or where the weld portion 18 is immersed in water, the welding strength can be maintained at a high level.

In this embodiment, instead of normal HDPE, the modified HDPE is used as the material to be alloyed together with EVOH. The reason therefor is as follows.

The normal HDPE has a low affinity to EVOH. Therefore, when the normal HDPE and EVOH are simply alloyed, large agglomerations of EVOH and HDPE are caused due to the non affinity of the normal HDPE and EVOH. Thus, EVOH and HDPE are partly localized.

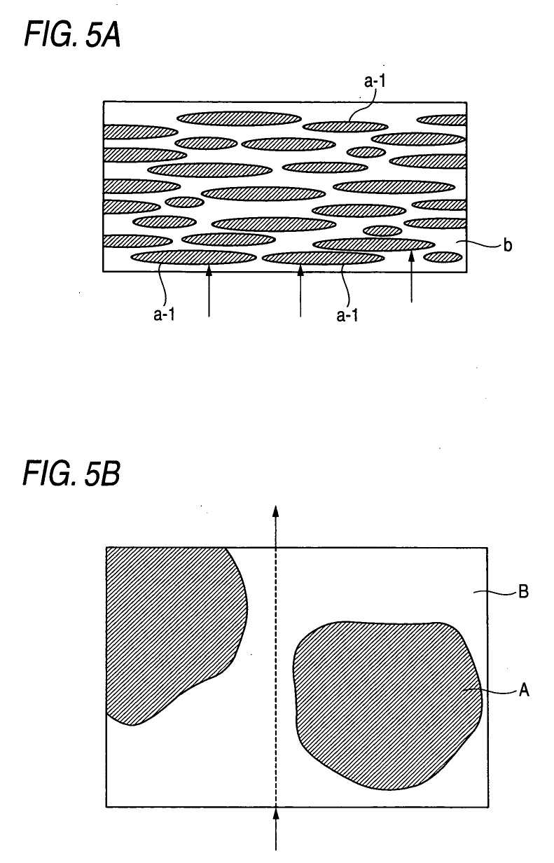

For example, as is schematically shown in FIG. 5B, large agglomerations A of EVOH are eccentrically located in a matrix of HDPE.

In this case, although EVOH itself excels in fuel impermeability, large agglomerations A of EVOH are separated from one another and are localized in the matrix B of HDPE. Consequently, a fuel gas easily passes between the agglomerations A of EVOH and goes out to the outside.

This is because of the facts that EVOH and HDPE are the combination of non compatible materials, thus, even when EVOH and HDPE are physically mixed with each other, the phase separation of EVOH and HDPE occurs. Accordingly, a low affinity phase boundary is formed.

Consequently, this mixture material (or blend material) is brought into a state in which the mixture material includes the large agglomerations A of EVOH almost like foreign materials. Thus, the strength of the mixture material becomes low (that is, the mixture material is put into a ragged condition). Also, phase boundary peeling becomes easy to occur on the boundary therebetween.

In contrast, this embodiment uses the modified HDPE resin, to which a functional group having chemical reactivity (mainly due to a hydrogen bond and a covalent bond) to a hydroxyl group of EVOH is introduced, as a material to be alloyed together with EVOH. Thus, this embodiment performs uniform mixing/dispersion of EVOH and HDPE, so that both EVOH and HDPE are blended with each other.

Consequently, both of the favorable weldability (that is, weldability at the weld portion 18) and the fuel-impermeability (the barrier property) are realized.

The uniform mixing/dispersion of EVOH and HDPE and the formation of a homogeneous phase, in which both EVOH and HDPE are blended with each other, can be realized due to the fact that as a result of being modified by introducing the functional group thereto, HDPE has a high affinity to EVOH.

Also, the strength and the impact resistance of the resin alloy material obtained by alloying EVOH and the modified HDPE are increased due to the fact that the uniform mixing/dispersion of EVOH and HDPE and the formation of a homogeneous phase, in which both EVOH and HDPE are blended with each other, is realized.

Examples of a modifying group, that is, the functional group to be introduced to HDPE are a carboxylic acid group, a carboxylic acid anhydride residue, an epoxy group, an acrylate group, a methacrylate group, a vinyl acetate group, and an amino group.

The welding strength can be increased by increasing the rate of HDPE, while the fuel impermeability can be increased by increasing the rate of EVOH. Thus, both the welding strength and the fuel impermeability can be controlled by adjusting the rates of HDPE and EVOH. The capacity ratio of EVOH to the modified HDPE can be set to range from (80/20) to (15/85).

The aforementioned composition of the resin alloy material includes no compatibilizing material. Thus, the resin alloy material excels in fuel impermeability. Incidentally, as need arises, a compatibilizing material, inorganic filler and so on may be blended in the resin alloy material. Incidentally, an excessive compatibilizing material may deteriorate the crystalline properties of a base material, so that the fuel impermeability is degraded (that is, the barrier ability is lowered). Thus, an amount of the compatibilizing material to be added should be set within a range in which the demanded barrier ability can be ensured.

In addition to the case of alloying the modified HDPE and EVOH, alloying may be performed on EVOH and both the normal HDPE and the modified HDPE.

In this embodiment, the resin alloy material may have a sea-island structure employing one of EVOH and the modified HDPE as a sea and also employing the other as an island. Especially, in a case where the sea-island structure employs the modified HDPE as a sea, and also employs EVOH as an island, the existence form of EVOH may be set so that the shape of each of the islands a-1 is flat, and that the islands are aligned in the same direction, as shown in FIG. 5A. In this case, the fuel impermeability can be enhanced, as compared with a case where each of the EVOH islands is spherical.

In the aforementioned embodiment, each of the weld portion 18 and the lower half part of the cylindrical portion 16 is configured to have a multi-layer structure including the inner layer member 36and the outer layer member 38. However, according to the invention, the welding joint may be configured so that only the weld portion 18 has the multi-layer structure including the inner layer member 36 and the outer layer member 38.

In this case, the invention can obtain an advantage in that reduction in the fuel impermeability due to moisture absorption by the inner layer member 36 in the weld portion 18 can favorably be prevented by the outer layer member 38 that externally covers the inner layer member 36.

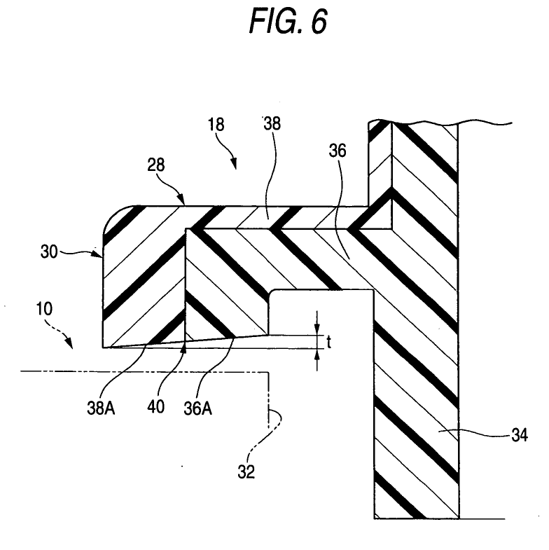

FIG. 6 shows another embodiment of the invention.

This example is configured to form the welding end surfaces 38A and 36A to be a slope so that the distance between the weld portion and the fuel tank 10 gradually increases toward the inner end of the welding end surface 36A of the inner layer member 36 from the outer end of the welding end surface 38A of the outer layer member 38.

Incidentally, the welding end surfaces 38A and 36A may be formed to be a curved surface, instead of the slope 40, so that the distance between the weld portion and the fuel tank 10 gradually increases toward the inner end of the welding end surface 36A from the outer end of the welding end surface 38A.

Also, in this embodiment, the difference t in dimension between the outer end of the welding end surface 38A and the inner end of the welding end surface 36A is set to be smaller than the welding margin, similarly to the aforementioned embodiment.

According to this embodiment, when the weld portion 18 is welded, first, the welding end surface 38A of the outer layer member 38 is welded. Subsequently, the welding end surface 36A of the inner layer member 36 is welded. Also, a molten part of each of the outer layer member 38 and the inner layer member 36 flows from the outer end of the welding end surface 38A to the inner end of the welding end surface 36A. Thus, there is no fear that a part of the inner layer member 36, which is molten at the welding end surface 36A, disturbs the welding between the outer layer member 38 and the fuel tank 10. Consequently, the strength of the weld portion 18 can be set at a high value. The reliability of the welding strength can be enhanced.

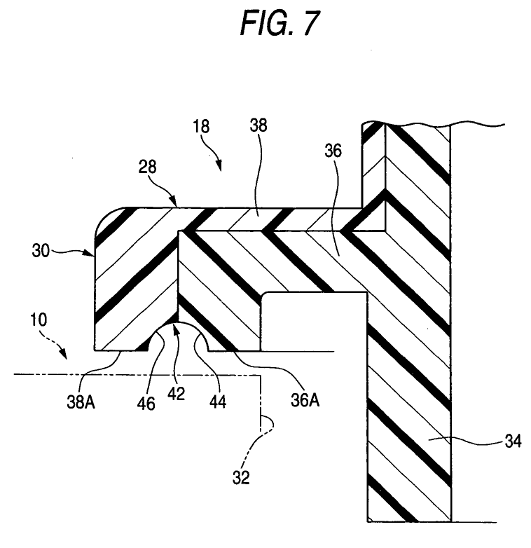

FIG. 7 shows still another embodiment of the invention.

This example is configured so that cross-sectionally circular-arc-shaped concave groove portions 46 and 44, each of which is annular-shaped around an opening portion 32, are respectively provided in a part of the welding end surface 38A of the outer layer member 38, which is located at the side of the inner layer member 36, and a part of the welding end surface 36A of the inner layer member 36, which is located at the side of the outer layer member 38. Thus, the groove portions 46 and 44 constitute a cross-sectionally semi-circular-shaped concave groove portion 42 extending over the welding end surface 38A of the outer layer member 38 and the welding end surface 36A of the inner layer member 36.

According to this embodiment, even in a case where a part of the inner layer member 36 is molten at the welding end surface 36A when welded, the molten part of the inner layer member 36 flows into the concave groove portion 42 and is stopped therein. Thus, the molten part of the inner layer member 36 is prevented from flowing into the welding end surface 38A of the outer layer member 38. Consequently, similarly to the embodiment shown in FIG. 6, the strength of the weld portion 18 can be set at a high value. Also, the reliability of the welding strength can be enhanced.

Incidentally, in the embodiment shown in FIG. 7, the concave groove portions 46 and 44 are provided in the welding end surfaces 38A and 36A, respectively. Depending on circumstances, only one of the groove portions may be provided.

The cross-section of each of the concave groove portions 46 and 44 may be formed into various shapes other than the shape shown in FIG. 7.

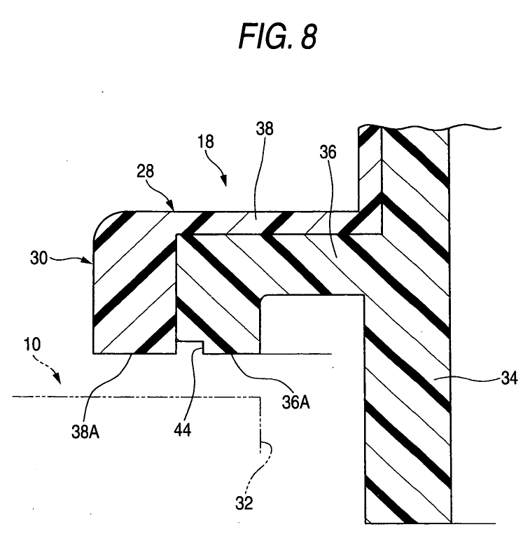

FIG. 8 shows an example of such a shape. As shown in this figure, a cross-sectionally rectangular-shaped concave groove portion 44 is provided in a part of the welding end surface 36A of the inner layer member 36, which is located at the side of the outer layer member 38.

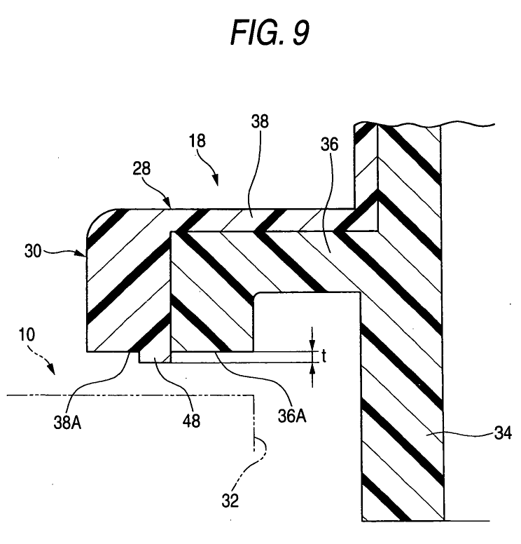

FIG. 9 shows yet another embodiment of the invention.

This example is configured so that an annular projection 48, which extends around the opening portion 32 and projects toward the fuel tank 10, is provided on a part of the welding end surface 38A of the outer layer member 38, which is located at the side of the inner layer member 36.

According to this embodiment, when the weld portion 18 is welded to the fuel tank 10, the partially projecting annular projection 48 is first welded thereto. Thus, the molten part of the inner layer member 36 is prevented from flowing into a part provided at the side of the outer layer member 38. Consequently, similarly to the aforementioned embodiments, the strength of the weld portion 18 can be set at a high value. Also, the reliability of the welding strength can be enhanced.

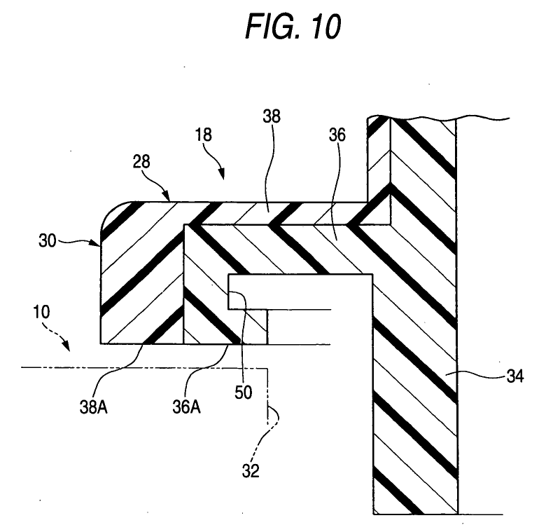

FIG. 10 shows a further embodiment of the invention.

This example is configured so that an annular cutout portion 50, which extends around the opening portion 32 and is concaved from the inner surface of the inner layer member 36 toward the outer layer member 38, is provided in a part of the inner layer member 36, which is located higher than the welding end surface 36A of the inner layer member 36.

According to this embodiment, the strength of the part of the inner layer member 36, which is located higher than the welding end surface 36A, is reduced by the annular cutout portion 50. Thus, when the welding end surface 36A of the inner layer member 36 is pushed down toward the fuel tank 10 after heat-molten, the inner layer member 36 is deformed in a direction to fill in the cutout portion 50. Consequently, the molten part of the inner layer member 36 can be prevented from flowing into a part provided at the side of the outer layer member 38. Thus, the strength of the weld portion 18 can be set at a high value. Also, the reliability of the welding strength can be enhanced.

Although the embodiments of the invention have been described above in detail, it should be understood that such description of the embodiments is for illustrative purposes only, and that various modifications can be made without departing from the spirit and the scope of the invention.

What is claimed is:

1. A welding joint for a fuel tank, comprising:
a cylindrical portion serving as a connection portion of a piping tube or connector; and
an annular weld portion provided at a base end part of the cylindrical portion, the weld portion being integrally heat-welded to a peripheral part of an opening portion of a resin fuel tank,
wherein at least the weld portion is configured to have a multi-layer structure formed by layering an inner layer member made of a resin alloy material obtained by alloying a modified HDPE, to which a functional group having a high affinity to a hydroxyl group of EVOH is introduced, and EVOH, or by alloying the modified HDPE, normal HDPE and EVOH, and an outer layer member which uses the HDPE resin and/or modified HDPE resin and has high weldability to the fuel tank,
each of the inner layer member and the outer layer member is heat-welded to the fuel tank at a corresponding welding end surface, and
in a vicinity of at least one of the welding end surface of the inner layer member and the welding end surface of the outer layer member, a flow preventing portion that prevent a molten part of the inner layer member from flowing toward the outer layer member is provided.

2. The welding joint for a fuel tank according to claim 1, wherein the flow preventing portion is configured such that the welding end surface of the outer layer member is projected toward the fuel tank from the welding end surface of the inner layer member, and a step-like portion is formed between the welding end surfaces, before heat-welded.

3. The welding joint for a fuel tank according to claim 1, wherein the flow preventing portion is configured such that the welding end surfaces are formed to be a slope or a curved surface so that a distance between the weld portion and the fuel tank gradually increases toward an inner end of the welding end surface of the inner layer member from an outer end of the welding end surface of the outer layer member, before heat-welded.

4. The welding joint for a fuel tank according to claim 1, wherein the flow preventing portion is configured such that an annular concave groove portion extending around the opening portion is provided on least one of a part of the welding end surface of the outer layer member, which is located at the side of the inner layer member, and a part of the welding end surface of the inner layer member, which is located at the side of the outer layer member, before heat-welded.

5. The welding joint for a fuel tank according to claim 1, wherein the flow preventing portion is configured such that an annular projection extending around the opening portion and projecting toward the fuel tank is provided on a part of the welding end surface of the outer layer member, which is located at the side of the inner layer member, before heat-welded.

6. The welding joint for a fuel tank according to claim 1, wherein the flow preventing portion is configured such that an annular cutout portion extending around the opening portion and concaved from an inner surface of the inner layer member toward the outer layer member is provided in a part of the inner layer member, which is located higher than the welding end surface of the inner layer member, before heat-welded.
